(19) United States
(12) Patent Application Publication
(10) Pub. No.: US 2017/0225153 A1
(43) Pub. Date: Aug. 10, 2017

(54) PHOTOCATALYST POWDER AND HYDROGEN PRODUCING SYSTEM

(71) Applicant: National Taiwan University of Science and Technology, Taipei (TW)

(72) Inventors: Dong-Hau Kuo, Taipei (TW); Hairus Abdullah, Taipei (TW)

(21) Appl. No.: 15/016,297

(22) Filed: Feb. 5, 2016

(51) Int. Cl. B01J 27/04; C01B 3/04; B01J 35/02; B01J 19/12; B01J 35/00

(52) U.S. Cl. CPC B01J 27/04; B01J 19/123; B01J 35/0013; B01J 35/004; B01J 35/023; C01B 3/042; B01J 2219/1203; B01J 2219/0877

(57) ABSTRACT

A photocatalyst powder is provided. The photocatalyst powder includes a plurality of nano crystallite aggregates formed by a plurality of nano crystallites. Each of the nano crystallites exhibits a single crystal structure. The nano crystallites have different compositions, different crystal phases, and different lattice constants from each other. An example of the nano crystallites is represented as the formula of ZnO₁₋ₓSₓ with different x values in each of the nano crystallites. In addition, a hydrogen producing system is also provided.

### CROSS-REFERENCE TO RELATED APPLICATION

This application claims the priority benefit of Taiwan application serial no. 104139030, filed on Nov. 24, 2015. The entirety of the above-mentioned patent application is hereby incorporated by reference herein and made a part of this specification.

### BACKGROUND OF THE INVENTION

1. Field of the Invention

The present invention generally relates to a photo catalyst powder and a hydrogen producing system using the photocatalyst powder. In particular, the present invention relates to a three-dimensional multiple quantum well (MQW)-type nano crystallite aggregate photocatalyst powder.

2. Description of Related Art

During the combustion of hydrogen, significant amount of heat is released, and the heat may be used in steam engine for electricity generation. Meanwhile, the byproduct of hydrogen combustion is water vapor, which is environmental friendly, and thus hydrogen is considered as green energy.

In order to promote the production of the hydrogen, a photocatalyst is generally adapted in the hydrogen producing process. Conventionally, the mainstream photocatalysts are divided into two types. The First type is TiO₂ based system, in which metal particles such as platinum, gold, silver, nickel, copper, palladium, or semiconductor particles of cadmium sulfide (CdS), cadmium zinc sulfide ((Cd, Zn)S), ruthenium oxide (RuO₂), or silver oxide (Ag₂O) are added. The second type is CdS-based system, in which a carbon material or metal particles such as platinum, nickel, or semiconductor particles of cadmium selenide (CdSe), zinc oxide (ZnO), titanium dioxide (TiO₂), gallium oxide (Ga₂O₃), indium oxide (In₂O₃), nickel sulfide (NiS), zinc sulfide (ZnS), palladium sulfide (PdS), or indium zinc sulfide (ZnIn₂S₄) are added.

Nevertheless, these types of photocatalyst systems are generally expensive or environmental harmful. Moreover, in order to enhance the hydrogen production rate, high power light sources are usually used in conjunction with these types of photocatalyst systems. High power light sources not only impose a burden on the cost of hydrogen production, but also raise safety issues on a scale-up production system. Therefore, providing a cost-effective photocatalyst which enhances the hydrogen production rate and efficiency while ensuring the safety during operation had become a topic to be researched in the field.

### SUMMARY OF THE INVENTION

The invention provides a photocatalyst powder and a hydrogen producing system using the photocatalyst powder, which is able to effectively increase the hydrogen production rate while maintaining high stability.

The invention provides a photocatalyst powder. The photocatalyst powder includes a plurality of nano crystallite aggregates formed by a plurality of nano crystallites. Each of the nano crystallites exhibits a single crystal structure, and the nano crystallites have different crystal phases, different compositions, and different lattice constants from each other.

In an embodiment of the invention, the nano crystallites have different bandgaps from each other.

In an embodiment of the invention, the photocatalyst powder is a three-dimensional multiple quantum well (MQW)-type nano crystallite aggregate powder.

In an embodiment of the invention, each of the nano crystallites includes a zinc oxysulfide solid solution type semiconductor.

In an embodiment of the invention, the nano crystallites are represented by the group consisting of formula (1):

ZnO₁₋ₓSₓ (1),
in formula (1), 0≦x≦1, and x is different in each of the nano crystallites.

In an embodiment of the invention, a size of the photocatalyst powder is 100 nm to 200 nm, and a size of each of the nano crystallites is 2 nm to 25 nm.

In an embodiment of the invention, the photocatalyst powder is formed in a temperature range of 50° C. to 150° C.

In an embodiment of the invention, the photocatalyst powder is formed by a solid solution treatment of a combination of compounds selected from metal oxide, metal sulfide, metal selenide, and metal telluride.

In an embodiment of the invention, the photocatalyst powder further includes heterogeneous nano additives.

In an embodiment of the invention, the heterogeneous nano additives include nickel and nickel oxide.

The invention provides a hydrogen producing system. The hydrogen producing system includes a plurality of photo reactors. Each of the photo reactors includes an aqueous solution, a light source, a production promoter, and the foregoing photocatalyst powder. The light source is capable of irradiating a light to the aqueous solution. The production promoter and the photocatalyst powder are located in the aqueous solution.

In an embodiment of the invention, a material of the production promoter includes an alcohol, an organic acid, an inorganic acid, an inorganic base, a metal salt, an amine, or a combination thereof.

Based on the above, the photocatalyst powder of the invention includes nano crystallites having a single crystal structure while encompassing different crystal phases, compositions, lattice constants, and bandgaps. In other words, the photocatalyst powder of the invention is a three-dimensional multiple quantum well (MQW)-type nano crystallite aggregate powder. Due to the specific structure of the photocatalyst powder of the invention, the lifetime of the photoelectron may be extended, thereby resulting in higher hydrogen production efficiency. As such, the power requirement for the light source may be reduced, and the safety of the operation is ensured. In addition, the photocatalyst powder of the invention may be recycled. Therefore, the cost for producing hydrogen may be significantly lowered.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a transmission electron microscope (TEM) image of a photocatalyst powder according to an embodiment of the invention.

FIG. 2 is an enlarged schematic view of a nano crystallite aggregate of the photocatalyst powder in FIG. 1.

FIG. 3 is the electron beam diffraction image of a region of the photocatalyst powder in FIG. 1 under TEM.

FIG. 4 is a schematic view of a hydrogen producing system according to an embodiment of the invention.

FIG. 5 is a diagram illustrating curves of hydrogen output versus hydrogen production duration of Examples 1 to 7 of the invention and Comparative Examples 1 to 2.

FIG. 6 is a diagram illustrating curves of hydrogen output versus hydrogen production duration of Example 1 and Example 8 of the invention.

FIG. 7 is a diagram illustrating curves of hydrogen output versus hydrogen production duration of Example 1 of the invention for undergoing repeated experiments for three consecutive days (Example 9).

FIG. 8 is a diagram illustrating curves of hydrogen output versus hydrogen production duration of Examples 8 and 10-12 of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

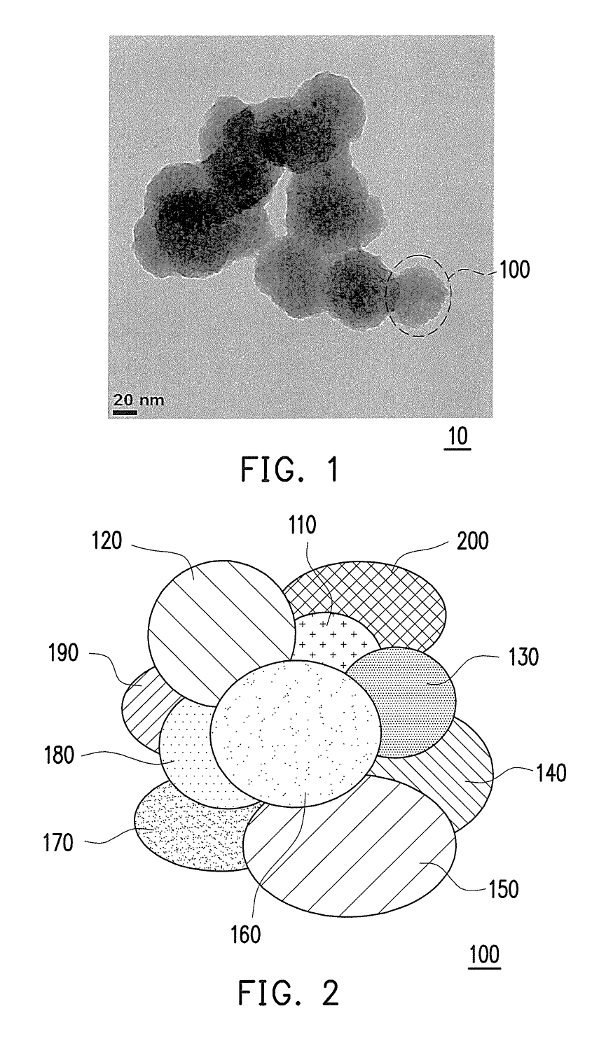

FIG. 1 is a transmission electron microscope (TEM) image of a photocatalyst powder 10 according to an embodiment of the invention. FIG. 2 is an enlarged schematic view of a nano crystallite aggregate 100 of the photocatalyst powder in FIG. 1. Referring to FIG. 1 and FIG. 2 simultaneously, the photocatalyst powder includes a plurality of nano crystallite aggregates 100. In an enlarged view, it can be seen that each of the nano crystallite aggregates 100 is constituted by a plurality of nano crystallites 110, 120, 130, 140, 150, 160, 170, 180, 190, and 200. The nano crystallites 110-200 are clustered together. A size of each of the nano crystallites 110-200 is generally greater than 2 nm. In particular, the size of each of the nano crystallites 110-200 ranges from 2 nm to 25 nm. It should be noted that the nano crystallites 110-200 may have identical size or different sizes, and the sizes of the nano crystallites 110-200 are not particular limited as long as the dimension falls within the foregoing range. The photocatalyst powder 10 formed by nano crystallite aggregates 100 generally has a size of greater than 50 nm. For example, the size of the photocatalyst powder 10 may range from 100 nm to 200 nm.

The photocatalyst powder 10 may be formed by a solid solution treatment of a combination of metal oxides, metal sulfide, metal selenide, or metal telluride at a low temperature. For example, under the circumstance where a solid solution treatment is performed on the combination of metal oxide and metal sulfide, the nano crystallites 110-200 obtained may be a zinc oxysulfide solid solution type semiconductor represented by the group consisting of formula (1):

ZnO₁₋ₓSₓ (1).

In formula (1), 0≦x≦1, and x is different in each of the nano crystallites 110-200. In other words, the compositions of each of the nano crystallites 110-200 are different. It should be noted that in the present embodiment, the raw materials of the photocatalyst powder are exemplified as zinc oxide and zinc sulfide, so the photocatalyst powder is represented by formula (1). However, they construe no limitation in the invention. In other embodiments, utilizing different combinations of metal oxides, metal sulfide, metal selenide, or metal telluride would render different molecular structure. The temperature for performing solid solution treatment is below 150° C., and preferably, between 50° C. to 150° C.

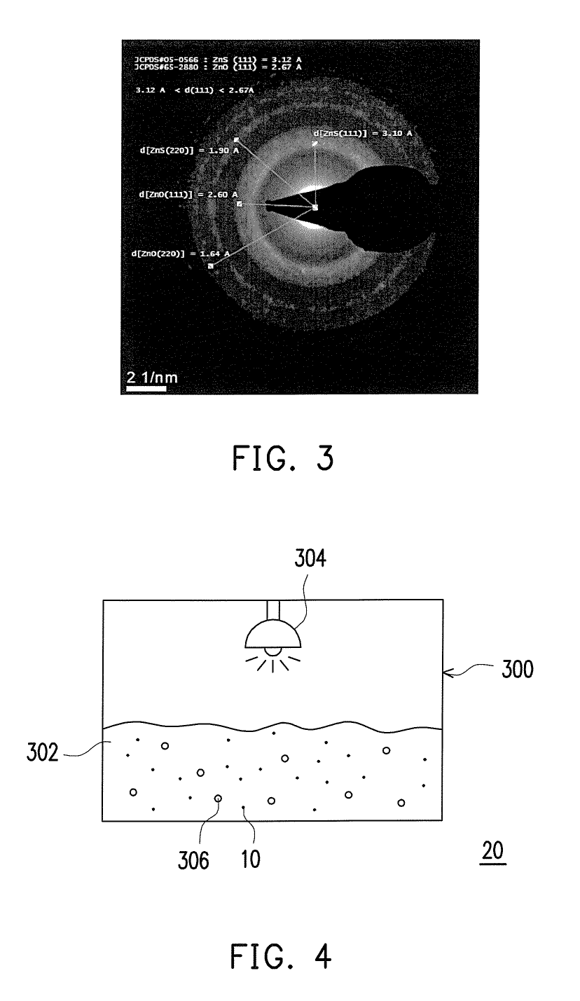

FIG. 3 is the electron beam diffraction image of a region of the photocatalyst powder 10 in FIG. 1 under TEM. Referring to FIG. 3, each of the diffraction patterns of the photocatalyst 10 exhibits an annular ring shape. As such, it is proven that the photocatalyst powder 10 encompasses a polycrystal structure constituted by multiple nano crystallites 110-200. Specifically, each of the nano crystallites 110-200 exhibits a single cubic crystal structure to form the polycrystalline structure of the photocatalyst powder 10. In addition, as illustrated in FIG. 3, each annular ring exhibits a visible width, which implies that the nano crystallites 110-200 do not have a constant lattice constant. In other words, each of the nano crystallites 110-200 has different compositions to lead to different crystal phases and different lattice constants from each other. For example, the nano crystallite 110 may have a lattice constant of d₁ at its (1 1 1) crystal plane while the nano crystallite 120 may have a lattice constant of d₂ at its (1 1 1), and the rest of the nano crystallites 130-200 further have different lattice constants. In addition to lattice constant differences, the nano crystallites 110-200 also have different bandgaps from each other due to the different phases. Since the bandgaps of the nano crystallites 110-200 are different, the photocatalyst powder 10 constituted by the nano crystallites 110-200 is a three-dimensional multiple quantum well (MQW)-type nano crystallite aggregate powder. In other words, each of the nano crystallites 110-200 is considered as a quantum well for trapping the electrons. Alternatively speaking, with the presence of the quantum wells due to nano crystallites 110-200, the photoelectron within the photocatalyst powder 10 is able to shift rapidly to a stable position, thereby avoiding the recombination of the electron and the hole. Since enough separation time is provided for the electron and the hole, reduction reactions of the electron and oxidation reaction of the holes may occur, and the production of hydrogen is achieved.

As mentioned above, since the photocatalyst powder 10 of the invention is obtained by performing a solid solution treatment on the combination of compounds selected from metal oxide, metal sulfide, metal selenide, and metal telluride, the nano crystallites 110-200 are tightly bonded to render fine interfaces. In other words, as compared to the structure obtained by a physically mixing mechanism, or alternatively, an artificial mixing mechanism, the photocatalyst powder 10 in the present invention is naturally formed, and thus the excellent interface would render superior three-dimensional quantum well structure and excellent photo-induced charge transfer.

In some embodiments, heterogeneous nano additives may be added to the photocatalyst powder to form a composite powder. The purpose of the heterogeneous nano additives is to enhance the hydrogen production rate. A material of the heterogeneous nano additives is selected from materials capable of transmitting charge carrier such as nickel or its oxide. However, the material of the heterogeneous nano additives is not limited thereto. Other suitable materials, or a combination thereof, having charge carrier transmitting property may be adapted as the heterogeneous nano additives of the present invention.

FIG. 4 is a schematic view of a hydrogen producing system 20 according to an embodiment of the invention. Referring to FIG. 4, the hydrogen producing system 20 includes a photo reactor 300, which can be in the different shapes of tube, barrel, dish etc. It should be noted that FIG. 4 illustrated a hydrogen producing system 20 with one photo reactor 300 as an example, but it construes no limitation in the present invention. In other embodiments, a scale-up photo reactor can be formed with the combinations of a plurality of the photo reactors 300. The photo reactor 300 includes an aqueous solution 302, a light source 304, a production promoter 306, and the photocatalyst powder 10. The aqueous solution 302 is, for example, deionized water, ethanol aqueous solution, sodium sulfide aqueous solution, or a combination thereof. The light source 304 is capable of irradiating a light to the aqueous solution 302. The light may be sun light or ultraviolet light, and the type of the light source 304 is not limited, as long as sufficient energy is provided for the reaction to occur. For example, an ultraviolet lamp may be adapted as the light source 304 of the present embodiment. The production promoter 306 is located in the aqueous solution 302, and the function of the production promoter 306 is to enhance the hydrogen production rate. In some other embodiments, the production promoter 306 may be referred as a hole scavenger or a sacrificial reagent. The production promoter 306 is, for example, an alcohol, an organic acid, and inorganic acid, and inorganic base, a metal salt, an amine, or a combination thereof.

The examples of the invention will be described in detail below.

### SYNTHESIS EXAMPLE 1

### Zinc Oxysulfide (ZnO₁₋ₓSₓ) Powder 1

4.4 grams of Zinc acetate (Zn(CH₃COO)₂.2H₂O) and 0.75 grams of Thioacetamide (CH₃CSNH₂) with a zinc:sulfur molar ratio of 1:0.5 is added to 900 mL of deionized water. The solution is heated to 50° C. while being stirred by a magnet for three hours. Subsequently, the precipitate is cooled and centrifuged. After rinsing the precipitate with alcohol for a few times, the precipitate is dried by an evaporator to obtain powder 1.

### EXAMPLE 1

### Photocatalytic Water Splitting for Hydrogen Generation with Deionized Water, Ethanol, and Powder 1

In Example 1, powder 1 is utilized as the photocatalyst powder. 405 mL of ionized water and 45 mL of ethanol are added to the photo reactor to form an alcohol aqueous solution. Subsequently, 225 mg of photocatalyst powder is added into the alcohol aqueous solution. Before irradiation with light, the photo reactor is filled with Argon gas at a flow rate of 100 mL/min for 2 hours. After the oxygen content in the photo reactor detected by gas chromatography is zero, the process of photocatalytic water splitting for hydrogen generation may be performed.

In Example 1, the light source is a Philips TL 6W black light ultraviolet lamp, and the light emitted has a wavelength of 352 nm. It should be noted that since approximately ⅓ of the lamp is located outside of the photo reactor in Example 1, the energy provided in Example 1 is approximately 4 W. In addition, the 4 W ultraviolet light is a weak light, and thus is harmless for human body. Moreover, the weak light would eliminate the requirement of a water-cooling system of the photo reactor.

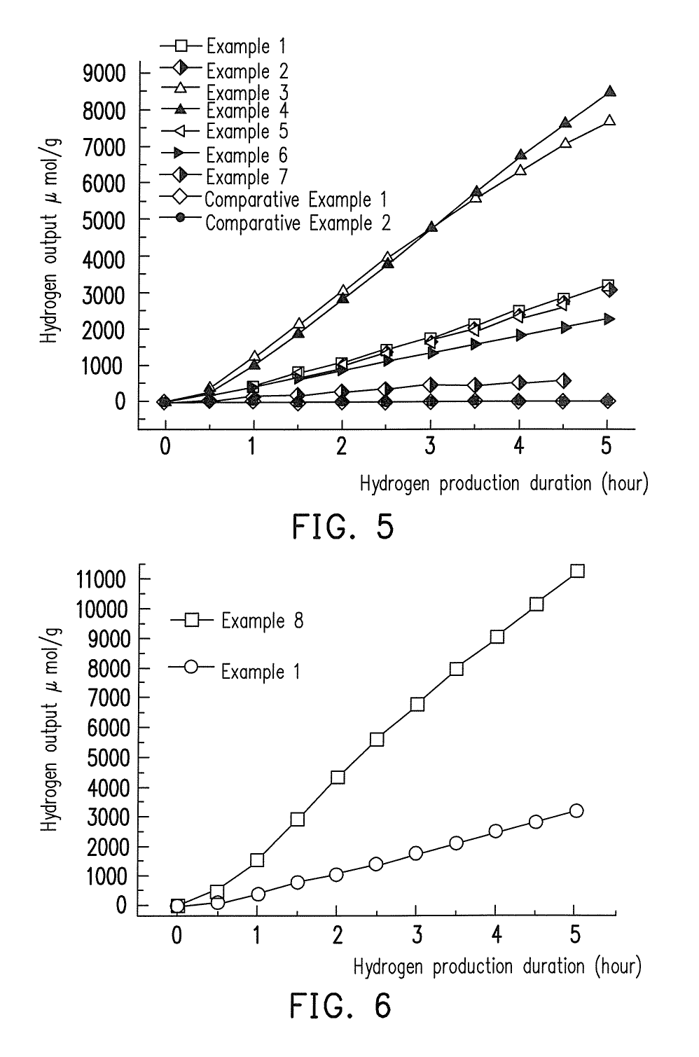

The Argon gas is turned off and the light is irradiated on the alcohol aqueous solution for 30 minutes. Subsequently, the light is turned off after 30 minutes, and the gas content in the photo reactor is measured and analyzed by the gas chromatography. Next, the same process is repeated every 30 minutes for 5 hours, and the curve of hydrogen output versus hydrogen production duration of Example 1 is illustrated in FIG. 5.

### SYNTHESIS EXAMPLE 2

### Zinc Oxysulfide (ZnO₁₋ₓSₓ) Powder 2

4.4 grams of Zinc acetate (Zn(CH₃COO)₂.2H₂O) and 1.5 grams of Thioacetamide (CH₃CSNH₂) with a zinc:sulfur molar ratio of 1:1 is used to perform the same synthesis process as that of Synthesis Example 1 to obtain powder 2.

### EXAMPLE 2

### Photocatalytic Water Splitting for Hydrogen Generation with Deionized Water, Ethanol, and Powder 2

Similar procedures as that of Example 1 are performed by using powder 2 as the photocatalyst powder. The curve of hydrogen output versus hydrogen production duration of Example 2 is illustrated in FIG. 5.

### EXAMPLE 3

### Photocatalytic Water Splitting for Hydrogen Generation with Sodium Sulfide Aqueous Solution and Powder 1

Example 3 utilizes powder 1 as the photocatalyst powder. 450 mL of deionized water and 8.8 grams of sodium sulfide are added to the photo reactor to form a sodium sulfide aqueous solution. Subsequently, 225 mg of photocatalyst powder is added into to the sodium sulfide aqueous solution, and similar procedures as that of Example 1 are performed. The curve of hydrogen output versus hydrogen production duration of Example 3 is illustrated in FIG. 5.

### EXAMPLE 4

### Photocatalytic Water Splitting for Hydrogen Generation with Sodium Sulfide, Ethanol, and Powder 1

Example 4 utilizes powder 1 as the photocatalyst powder. 405 mL of deionized water, 45 mL of ethanol, and 8.8 grams of sodium sulfide are added to the photo reactor to form a mixed aqueous solution. Subsequently, 225 mg of photocatalyst powder is added into the mixed aqueous solution, and similar procedures as that of Example 1 are performed. The curve of hydrogen output versus hydrogen production duration of Example 4 is illustrated in FIG. 5.

### EXAMPLE 5

### Photocatalytic Water Splitting for Hydrogen Generation with 50 wt % Ethanol Aqueous Solution and Powder 1

Example 5 utilizes powder 1 as the photocatalyst powder. 225 mL of deionized water and 225 mL of ethanol are added to the photo reactor to form an ethanol aqueous solution. Subsequently, 225 mg of photocatalyst powder is added into to the ethanol aqueous solution, and similar procedures as that of Example 1 are performed. The curve of hydrogen output versus hydrogen production duration of Example 5 is illustrated in FIG. 5.

### EXAMPLE 6

### Photocatalytic Water Splitting for Hydrogen Generation with 100 wt % Ethanol Solution and Powder 1

Example 6 utilizes powder 1 as the photocatalyst powder. In the photo reactor, 225 grams of photocatalyst powder is added to 450 mL of ethanol, and similar procedures as that of Example 1 are performed. The curve of hydrogen output versus hydrogen production duration of Example 6 is illustrated in FIG. 5.

### EXAMPLE 7

### Photocatalytic Water Splitting for Hydrogen Generation with Deionized Water and Powder 1

Example 7 utilizes powder 1 as the photocatalyst powder. In the photo reactor, 225 grams of photocatalyst powder is added to 450 mL of deionized water, and similar procedures as that of Example 1 are performed. The curve of hydrogen output versus hydrogen production duration of Example 7 is illustrated in FIG. 5.

### COMPARATIVE EXAMPLE 1

### Photocatalytic Water Splitting for Hydrogen Generation with Deionized Water, Ethanol, and Zinc Oxide Powder

In Comparative Example 1, the synthesis condition of zinc oxide powder is similar to that of the Synthesis Example 1 except no Thioacetamide (CH₃CSNH₂) is added and the reaction temperature is elevated to 90° C. Subsequently, the zinc oxide powder is utilized as the photocatalyst powder, and similar procedures as that of Example 1 are performed. The curve of hydrogen output versus hydrogen production duration of Comparative Example 1 is illustrated in FIG. 5.

### COMPARATIVE EXAMPLE 2

### Photocatalytic Water Splitting for Hydrogen Generation with Deionized Water, Ethanol, and Commercially Available Zinc Sulfide Powder

In Comparative Example 2, commercially available zinc sulfide powder is utilized as the photocatalyst powder and similar procedures as that of Example 1 are performed. The curve of hydrogen output versus hydrogen production duration of Comparative Example 2 is illustrated in FIG. 5.

FIG. 5 is a diagram illustrating curves of hydrogen output versus hydrogen production duration of Examples 1 to 7 of the invention and Comparative Examples 1 to 2. The numerical values of the hydrogen production rate for Examples 1-7 and Comparative Examples 1-2 are summarized in Table 1 below.

TABLE 1

| | | | | | | | 5 hrs |
|---|---|---|---|---|---|---|---|
| | Zn:S | | 10% | 50% | 100% | | hydrogen |
| | (molar | 100% | eth- | eth- | eth- | 8.8 g | Output |
| Trials | ratio) | water | anol | anol | anol | NaS | (μmol/g) |
| Example 1 | 1:0.5 | | V | | | | 3159 |
| Example 2 | 1:1 | | V | | | | 3081 |
| Example 3 | 1:0.5 | | | | | V | 7716 |
| Example 4 | 1:0.5 | | V | | | V | 8457 |
| Example 5 | 1:0.5 | | | V | | | 2636 |
| Example 6 | 1:0.5 | | | | V | | 2277 |
| Example 7 | 1:1 | V | | | | | 545 |
| Comparative | | | V | | | | 7 |
| Example 1 | | | | | | | |
| Comparative | | | V | | | | 21 |
| Example 2 | | | | | | | |

Referring to FIG. 5 and Table 1 simultaneously, under different conditions and in different aqueous solutions, the ZnO₁₋ₓSₓ photocatalyst powder of the present invention is able to aid the production of hydrogen. On the other hand, since Comparative Examples 1-2 yield low hydrogen production rate, it is apparent that the zinc oxide powder and the zinc sulfide powder in Comparative Examples 1-2 are not capable of aiding the hydrogen production process.

It should be noted that Example 4 with the addition of Na₂S yields the largest hydrogen output. Specifically, the total hydrogen output after 5 hours is 8457 μmol/g, the hydrogen production rate is 1691 μmol/g·h, and the hydrogen production rate per watt is 423 μmol/g·h·watt. On the other hand, Example 3 with the addition of Na₂S yields the second largest hydrogen output. Specifically, the total hydrogen output after 5 hours is 7716 μmol/g, the hydrogen production rate is 1543 μmol/g·h, and the hydrogen production rate per watt is 386 μmol/g·h·watt.

When ethanol aqueous solution is used, the total hydrogen output is approximately 2636 to 3159 μmol/g, the hydrogen production rate is approximately 527 to 632 μmol/g·h, and the hydrogen production rate per watt is approximately 132 to 158 μmol/g·h·watt. The preferred embodiment includes the usage of 10 wt % ethanol aqueous solution.

### EXAMPLE 8

### Photocatalytic Water Splitting for Hydrogen Generation with 10 wt % Ethanol Aqueous Solution and Powder 1 Under 16 W Light Source

In Example 8, powder 1 is utilized as the photocatalyst powder. 405 mL of deionized water and 45 mL of ethanol are added to the photo reactor to form an ethanol aqueous solution. Subsequently, 225 mg of photocatalyst powder is added into to the ethanol aqueous solution. In Example 8, the light source is composed of four Philips TL 6 W black light ultraviolet lamps, and the light emitted has a wavelength of 352 nm. It should be noted that since approximately ⅓ of the lamp is located outside of the photo reactor in Example 8, the energy provided in Example 8 is approximately 16 W. Similar procedures as that of Example 1 are performed. The curve of hydrogen output versus hydrogen production duration of Example 8 is illustrated in FIG. 6.

FIG. 6 is a diagram illustrating curves of hydrogen output versus hydrogen production duration of Example 1 and Example 8 of the invention. Referring to FIG. 6, Example 1 and Example 8 essentially utilize identical experimental parameter except the energy provided by the light source is higher in Example 8. As illustrated in FIG. 6, in Example 8, the total hydrogen output after 5 hours is 11250 μmol/g, the hydrogen production rate is 2250 μmol/g·h, and the hydrogen production rate per watt is 141 μmol/g·h·watt. On the other hand, in Example 1, the total hydrogen output after 5 hours is 3159 μmol/g, the hydrogen production rate is 632 μmol/g·h, and the hydrogen production rate per watt is 158 μmol/g·h·watt. FIG. 6 illustrates that the hydrogen output under 4 lamps is 3.56 times greater than the hydrogen output under 1 lamp. Take into account of the interactions among the 4 lamps, the hydrogen output is quite linearly increased as the energy provided by the light is increased.

### EXAMPLE 9

### Photocatalytic Water Splitting for Hydrogen Generation with Deionized Water, Ethanol, and Powder 1 for Multiple Days

In order to investigate the recyclability of the photocatalyst powder of the present invention, Example 9 performs the procedures in Example 1 thrice in three consecutive days. In detail, the processes of Example 1 are performed for 5 hours during the first day. Subsequently, same processes are repeated for the second day and the third day. It should be noted that the aqueous solution and the photocatalyst powder in Example 9 are not being changed during the three days period.

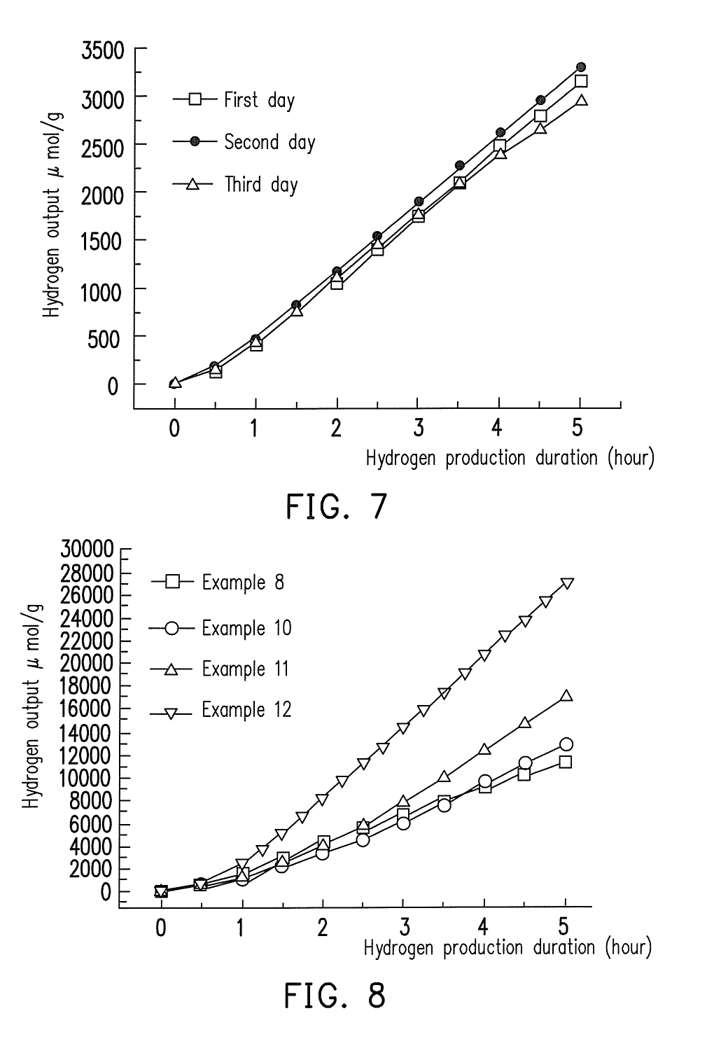

FIG. 7 is a diagram illustrating curves of hydrogen output versus hydrogen production duration of Example 1 of the invention for undergoing repeated experiments for three consecutive days (Example 9). As illustrated in FIG. 7, the hydrogen production rate after 5 hours is 3159 μmol/g during the first day, 3293 μmol/g during the second day, and 2931 μmol/g during the third day. The hydrogen production ability yields no significant decay. As such, it is apparent that the hydrogen producing system utilizing the photocatalyst powder of the present invention may eliminate the step of replacing the aqueous solution, which enhances the convenience while reducing the cost.

### SYNTHESIS EXAMPLE 3

### Zinc Oxysulfide (ZnO₁₋ₓSₓ) Powder 3

The procedures in Synthesis Example 3 are identical to Synthesis Example 1 except the reaction temperature is elevated to 70° C. to obtain powder 3.

### EXAMPLE 10

### Photocatalytic Water Splitting for Hydrogen Generation with 10 wt % Ethanol Aqueous Solution and Powder 3 Under 16 W Light Source

Example 10 utilizes powder 3 as the photocatalyst powder, and similar procedures as that of Example 8 are performed. The curve of hydrogen output versus hydrogen production duration of Example 10 is illustrated in FIG. 8.

### SYNTHESIS EXAMPLE 4

### Zinc Oxysulfide (ZnO₁₋ₓSₓ) Powder 4

The procedures in Synthesis Example 4 are identical to Synthesis Example 1 except the reaction temperature is elevated to 90° C. to obtain powder 4.

### EXAMPLE 11

### Photocatalytic Water Splitting for Hydrogen Generation with 10 wt % Ethanol Aqueous Solution and Powder 4 Under 16W Light Source

Example 11 utilizes powder 4 as the photocatalyst powder, and similar procedures as that of Example 8 are performed. The curve of hydrogen output versus hydrogen production duration of Example 11 is illustrated in FIG. 8.

### SYNTHESIS EXAMPLE 5

### Zinc Oxysulfide (ZnO₁₋ₓSₓ) Powder 5

4.4 grams of Zinc acetate (Zn(CH₃COO)₂.2H₂O) and 0.75 grains of Thioacetamide (CH₃CSNH₂) with a zinc:sulfur molar ratio of 1:0.5 are added to 900 mL of deionized water. In addition to Zinc acetate and Thioacetamide, 0.442 grams of nickel chloride (NiCl₂) is also added to the deionized water. The solution is heated to 90° C. while being stirred by a magnet for four hours. Subsequently, diluted hydrazine (N₂H₄.H₂O) solution is added and then stirred for another 12 hours until the solution appears to be light yellow color. After cooling, the solution is centrifuged and the precipitate is rinsed with alcohol for a few times. Next, the precipitate is dried by an evaporator to obtain powder 5.

### EXAMPLE 12

### Photocatalytic Water Splitting for Hydrogen Generation with 10 wt % Ethanol Aqueous Solution and Powder 5 Under 16 W Light Source

Example 12 utilizes powder 5 as the photocatalyst powder, and similar procedures as that of Example 8 are performed. The curve of hydrogen output versus hydrogen production duration of Example 12 is illustrated in FIG. 8.

FIG. 8 is a diagram illustrating curves of hydrogen output versus hydrogen production duration of Examples 8 and 10-12 of the invention. As illustrated in FIG. 8, in Example 10 (powder 3 has a synthesis temperature of 70° C.), the total hydrogen output after 5 hours is 12796 μmol/g, the hydrogen production rate is 2559 μmol/g·h, and the hydrogen production rate per watt is 160 μmol/g·h·watt. On the other hand, in Example 11 (the powder 4 has a synthesis temperature of 90° C.), the total hydrogen output after 5 hours is 17023 μmol/g, the hydrogen production rate is 3405 μmol/g·h, and the hydrogen production rate per watt is 213 μmol/g·h·watt. FIG. 8 illustrates that the hydrogen production rate increases as the increase in photocatalyst powder synthesis temperature.

Moreover, as illustrated in FIG. 8, in Example 12 (with the addition of NiCl₂ during synthesis), the total hydrogen output after 5 hours is 27100 μmol/g, the hydrogen production rate is 5420 μmol/g·h, and the hydrogen production rate per watt is 339 μmol/g·h·watt. By addition of heterogeneous nano additive, the composite powder may enhance the hydrogen production rate. In Example 12, through the reduction reaction between hydrazine and NiCl₂, the nano nickel may precipitate to stay on the surface of the Zinc Oxysulfide nano crystallite aggregate powder followed by the surface oxidation to form the Ni core/NiO shell nano structure, thereby enhancing the hydrogen production rate significantly.

### SYNTHESIS EXAMPLE 6

### Zinc Oxysulfide (ZnO₁₋ₓSₓ) Powder 6

4.4 grams of Zinc acetate (Zn(CH₃COO)₂.2H₂O) and 0.75 grams of Thioacetamide (CH₃CSNH₂) with a zinc:sulfur molar ratio of 1:0.5 is added to 400 mL of deionized water. After magnetic stirring the solution to dissolve the Zinc acetate and Thioacetamide, the solution is placed in a 500 mL autoclave and heated to 150° C. for 3 hours. Subsequently, the precipitate is cooled and centrifuged. After rinsing the precipitate with alcohol for a few times, the precipitate is dried by an evaporator to obtain powder 6.

### EXAMPLE 13

### Photocatalytic Water Splitting for Hydrogen Generation with 10 wt % Ethanol Aqueous Solution and Powder 6 Under 16 W Light Source

Example 13 utilizes powder 6 as the photocatalyst powder, and similar procedures as that of Example 8 are performed. In Example 13, the total hydrogen output after 5 hours is 7912 μmol/g, the hydrogen production rate is 1582 μmol/g·h, and the hydrogen production rate per watt is 99 μmol/g·h·watt. Example 13 demonstrates that when the photocatalyst powder undergoes hydrothermal reaction with higher synthesis temperature in the autoclave, the hydrogen production may still be attained.

Based on the foregoing, the three-dimensional multiple quantum well (3D-MQW)-type nano crystallite aggregate powder provided by the invention includes several advantages. For example, the hydrogen production rate may be effectively enhanced. In addition, the power requirement for the light source may be reduced, and the safety of the operation for a scale-up system is ensured. Moreover, the hydrogen producing system utilizing the photocatalyst powder may eliminate the step of replacing the aqueous solution, which enhances the convenience while reducing the cost.

In addition, hydrogen production is only one application of the photocatalyst powder of the invention, but it construes no limitation in the present invention. Others applications such as the reactions of organic, inorganic, heavy metal ions etc. may utilize the photocatalyst powder of the invention. For example, during a CO₂-reduction reaction between carbon dioxide and hydrogen to form hydrocarbons, the photocatalyst of the present invention may be adapted. Alternatively, hexavalent chromium reduction may also utilize the photocatalyst powder of the invention.

Since the quantum well structure of the photocatalyst powder is able to render a longer lifetime of the photo-induced charges of electron and hole, the photocatalyst powder may also be applicable to various optical elements such as solar cells, optical sensors, light reactor, light-sensitive medical instruments, or the like.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. A photocatalyst powder, comprising a plurality of nano crystallite aggregates formed by a plurality of nano crystallites, wherein each of the nano crystallites exhibits a single crystal structure, and the nano crystallites have different compositions, different crystal phases, and different lattice constants from each other.

2. The photocatalyst powder according to claim 1, wherein the nano crystallites have different bandgaps from each other.

3. The photocatalyst powder according to claim 1, wherein the photocatalyst powder is a three-dimensional multiple quantum well (MQW)-type nano crystallite aggregate powder.

4. The photocatalyst powder according to claim 1, wherein each of the nano crystallites comprises a zinc oxysulfide solid solution type semiconductor.

5. The photocatalyst powder according to claim 4, wherein the nano crystallites are represented by the group consisting of formula (1):
ZnO₁₋ₓSₓ (1),
in formula (1), O≦x≦1, and x is different in each of the nano crystallites.

6. The photocatalyst powder according to claim 1, wherein a size of the photocatalyst powder is 100 nm to 200 nm, and a size of each of the nano crystallites is 2 nm to 25 nm.

7. The photocatalyst powder according to claim 1, wherein the photocatalyst powder is formed in a temperature range of 50° C. to 150° C.

8. The photocatalyst powder according to claim 1, wherein the photocatalyst powder is formed by a solid solution treatment of a combination of compounds selected from metal oxide, metal sulfide, metal selenide, and metal telluride.

9. The photocatalyst powder according to claim 1, further comprising heterogeneous nano additives.

10. The photocatalyst powder according to claim 9, wherein the heterogeneous nano additives comprise nickel and nickel oxide.

11. A hydrogen producing system, comprising:
a plurality of photo reactors, wherein each of the photo reactors comprises:
an aqueous solution;
a light source, capable of irradiating a light to the aqueous solution;
a production promoter located in the aqueous solution; and
a photocatalyst powder of claims 1-10, wherein the photocatalyst powder is located in the aqueous solution.

12. The hydrogen producing system according to claim 11, wherein a material of the production promoter comprises an alcohol, an organic acid, an inorganic acid, an inorganic base, a metal salt, an amine, or a combination thereof.
